(19) United States
(12) Patent Application Publication
(10) Pub. No.: US 2007/0120356 A1
(43) Pub. Date: May 31, 2007

(54) Planner booklet

(75) Inventor: Harolde M. Savoy, Dallas, TX (US)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: LES ENTREPRISES DOMINION BLUELINE INC.

(21) Appl. No.: 11/606,207

(22) Filed: Nov. 30, 2006

Related U.S. Application Data
(60) Provisional application No. 60/740,666, filed on Nov. 30, 2005.

(51) Int. Cl. B42D 1/00

(52) U.S. Cl. 281/16

(57) ABSTRACT

A planner booklet with a set of pages including a plurality of note pages bearing date indicia and bound together. The planner has a front cover flexibly connected to a back cover and an extension flap flexibly connected to the back cover. The flap has a receiving pocket for receiving the solid page of the set of pages or alternatively has a binding device for binding the set of pages. The flap is movable between an extended position where the flap is positioned away from the back cover and a retracted position where the flap is positioned against the back cover. In use, a user is able to flip the note pages underneath the solid page or the flap by moving the flap between the extended and retracted positions.

### FIELD OF THE INVENTION

The present invention relates to a planner booklet.

### BACKGROUND OF THE INVENTION

Monthly or weekly planners are well known in the art. These planners contain a set of pages where a user may write in entries corresponding to a day of the week or to a month of the year. The set of pages are usually bound together and attached to a central spine located between a front cover and a back cover. One problem of the known planners is that, when the booklet is closed, the user has to search for the right page corresponding to the current date. One way of solving this problem has been to provide a bottom corner portion that a user may tear to keep up with the current date. However, the user has to remember to tear out the corner portion regularly to keep it up to date.

There is therefore need for an improved planner booklet that addresses the above-identified problem.

Also known in the art, there are EP Patent Application No. 0,567,714 (RAGOSTA), U.S. Pat. No. 5,104,146 (SCHULZ et al.) and US Patent Publication No. 2003/0209903 (MORRIS), which do not address the above-identified problem.

### SUMMARY OF THE INVENTION

According to the present invention, there is provided a planner booklet, comprising:
a set of pages including a plurality of note pages bearing date indicia and a solid page;
a binding means for binding together the set of pages;
a front cover having a first side and a second side;
a back cover having a first side and a second side, the first side of the back cover being flexibly connected to the second side of the front cover; and
an extension flap having a first side and a second side, the first side of the flap being flexibly connected to the second side of the back cover, the second side of the flap having a receiving pocket for receiving the solid page of the set of pages, the flap being movable between an extended position where the flap is positioned away from the back cover and a retracted position where the flap is positioned against the back cover, whereby, when the solid page is inserted in the receiving pocket of the flap, a user is able to flip the note pages underneath the solid page by moving the flap between the extended and retracted positions.

According to another aspect of the present invention, there is also provided a planner booklet, comprising:
a set of pages including a plurality of note pages bearing date indicia;
a front cover having a first side and a second side;
a back cover having a first side and a second side, the first side of the back cover being flexibly connected to the second side of the front cover; and
an extension flap having a first side and a second side, the first side of the flap being flexibly connected to the second side of the back cover, the second side of the flap having a binding means for binding together the set of pages, the flap being movable between an extended position where the flap is positioned away from the back cover and a retracted position where the flap is positioned against the back cover, whereby, in use, a user is able to flip the note pages underneath the flap by moving the flap between the extended and retracted positions.

Preferably, the front cover includes a transparent strip or clear window portion for allowing a user to reference the set of pages when the front cover is closed. This feature is particularly advantageous in a planner booklet that includes an identification of the current date or month which is in register with the clear window portion. In this way, a user may fold the pages underneath the other pages, and view the newly weekly or monthly reference through the clear window portion when the front cover is closed.

The invention, as well as its numerous advantages will be better understood by reading of the following non-restrictive description of preferred embodiments made in reference to the appended drawings.

### BRIEF DESCRIPTION OF THE FIGURES

FIG. 1 is a perspective view of a monthly planner booklet in a generally closed position with a front cover thereof being slightly lifted by a user, according to a preferred embodiment of the present invention.

FIG. 2 is a perspective view of the monthly planner booklet shown in FIG. 1, in an open position.

FIG. 3a is a perspective view of a weekly planner booklet similar to the monthly planner booklet shown in FIG. 2, with one note page thereof being turned left by a user.

FIG. 3b is a perspective view of the monthly planner booklet shown in FIG. 2, with one page thereof being turned left by a user.

FIG. 4 is a perspective view of the monthly planner booklet shown in FIG. 2, with a set of pages flexibly connected to a flap that is flexibly connected to a back cover of the planner booklet, the flap and set of pages being lifted by a user and one page of a telephone directory page being lifted by the user.

FIG. 5 is a perspective view of the monthly planner booklet shown in FIG. 2, with a first series of pages being separated from a second series of pages by a user.

FIG. 6 is a perspective view of the monthly planner booklet shown in FIG. 5, with the first series of pages being flipped to the left underneath the second series of pages by a user.

FIG. 7 is a perspective view of the monthly planner shown in FIG. 5, with the flap that holds the pages being positioned in an extended position.

FIG. 8 is a perspective view of the monthly planner shown in FIG. 5, with the flap that holds the pages being positioned in a retracted position.

FIG. 9 is a perspective view of the monthly planner shown in FIG. 5, with the flap being in the extended position and having a receiving pocked for removably inserting a solid page of a set pages of the planner booklet bound together by annular rings.

### DETAILED DESCRIPTION OF THE INVENTION

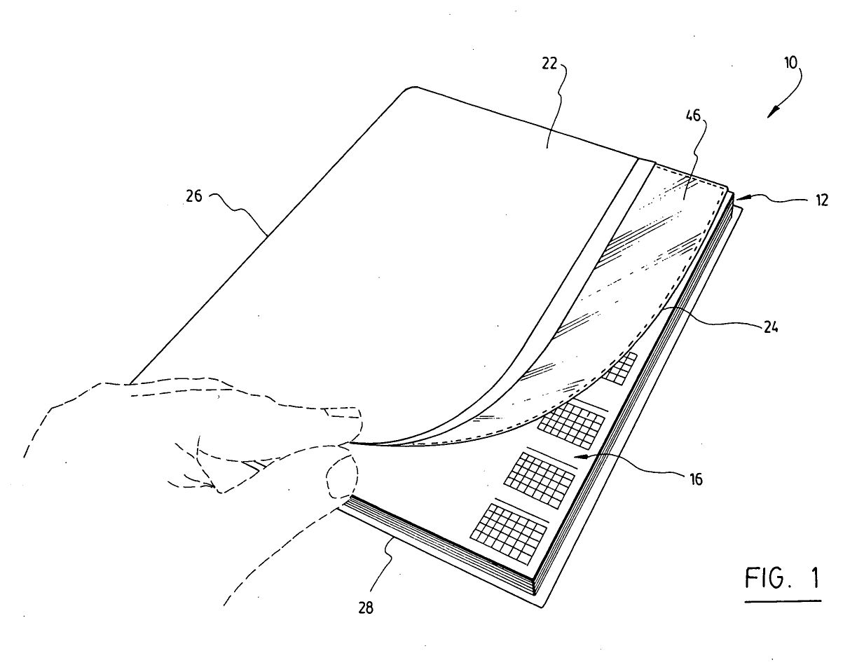

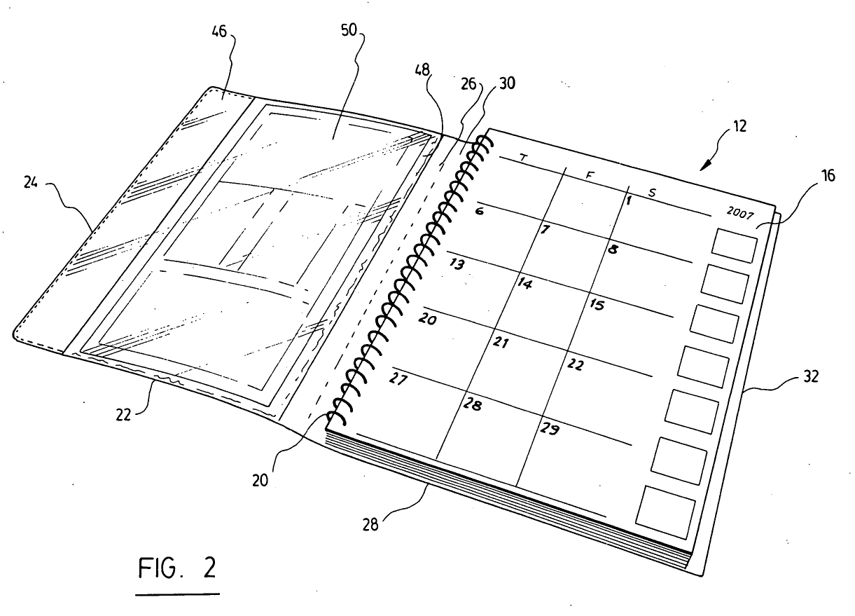

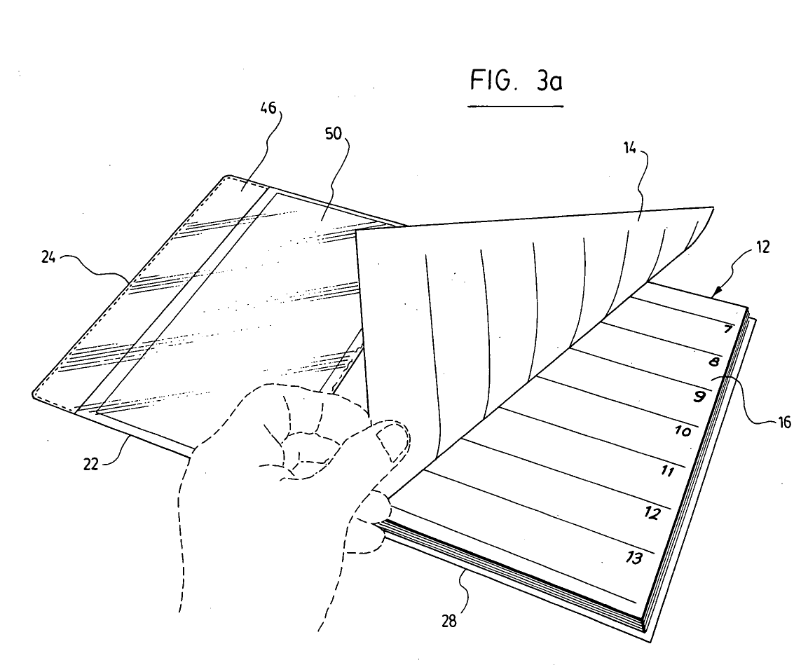

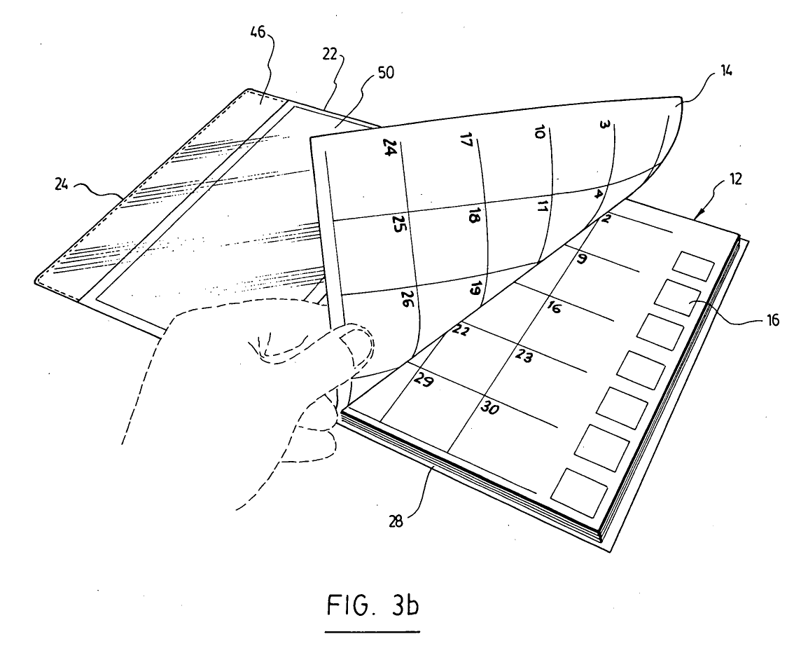

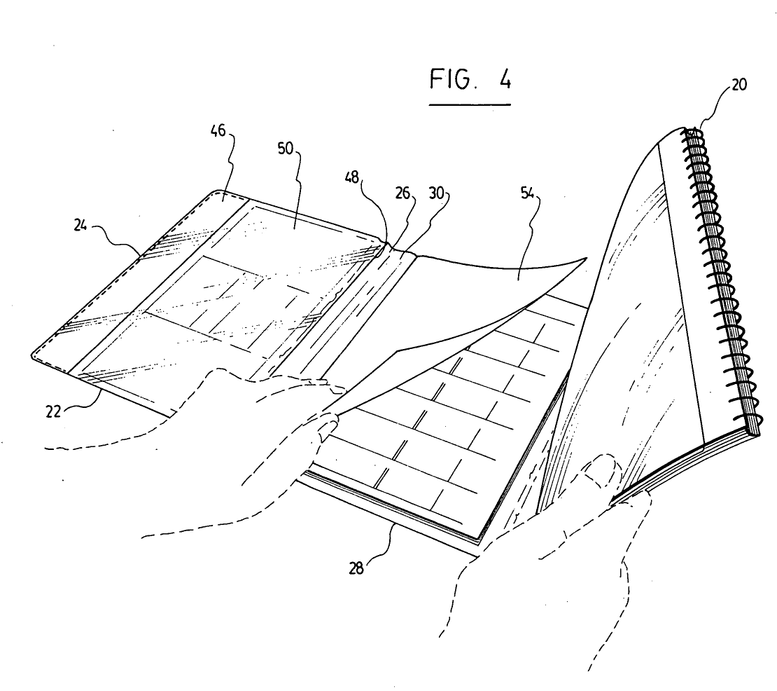

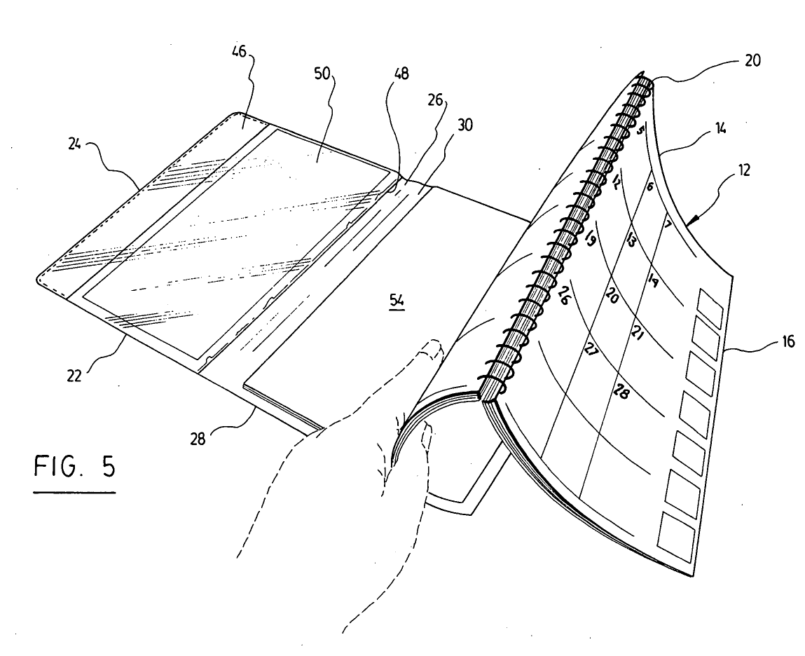

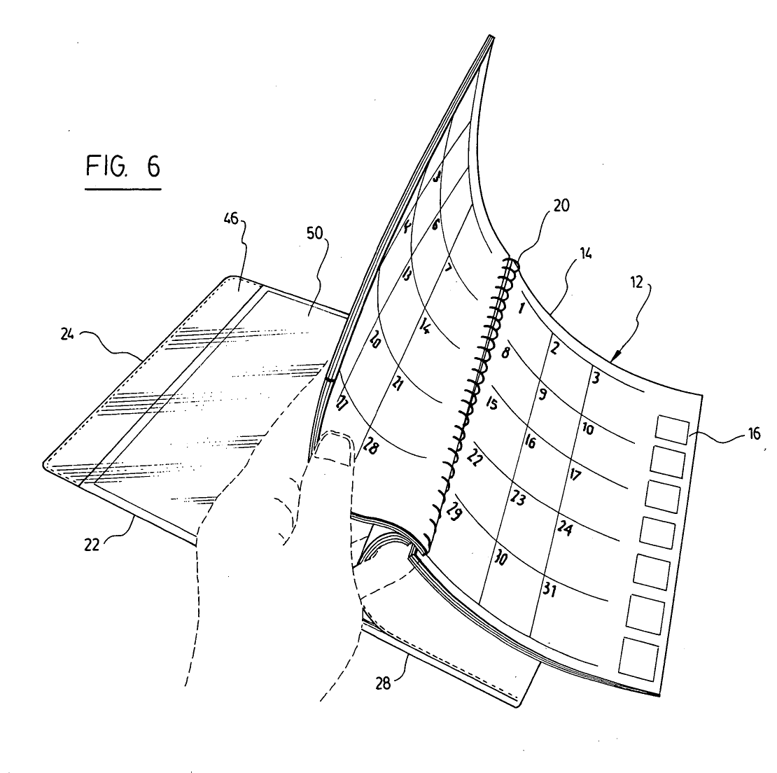

Referring to FIGS. 1 to 9, there is shown a planner booklet 10 according to preferred embodiments of the present invention. The planner booklet 10 may be a monthly planner as shown in FIGS. 1, 2 and 3b, or a weekly planner as shown in FIG. 3a. Other variations of date indicia on the planner booklet may also be used as persons skilled in the art will understand.

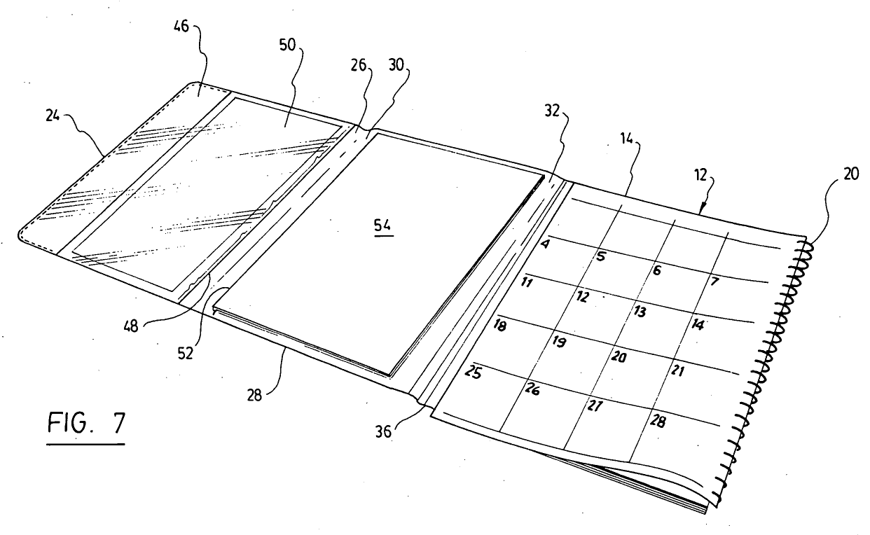

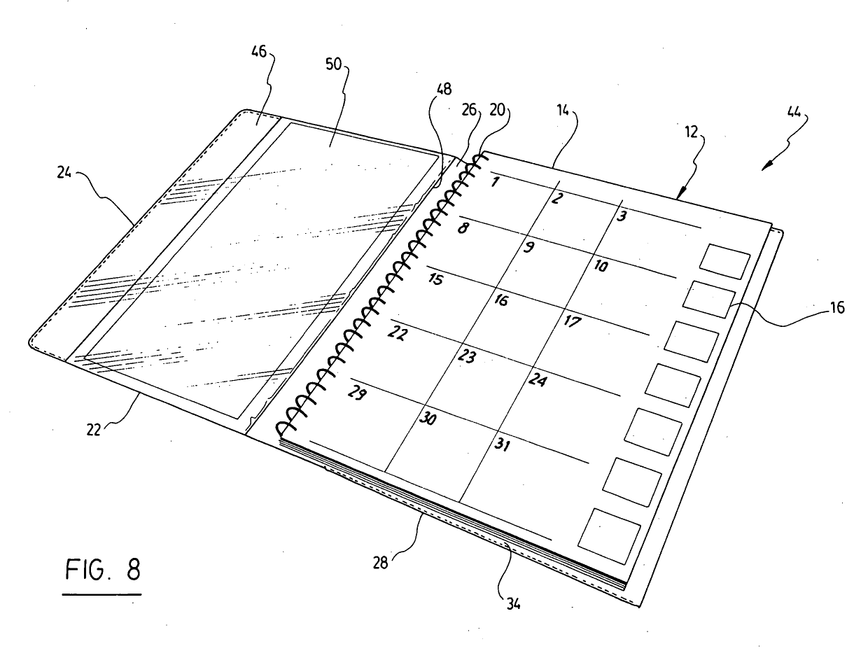

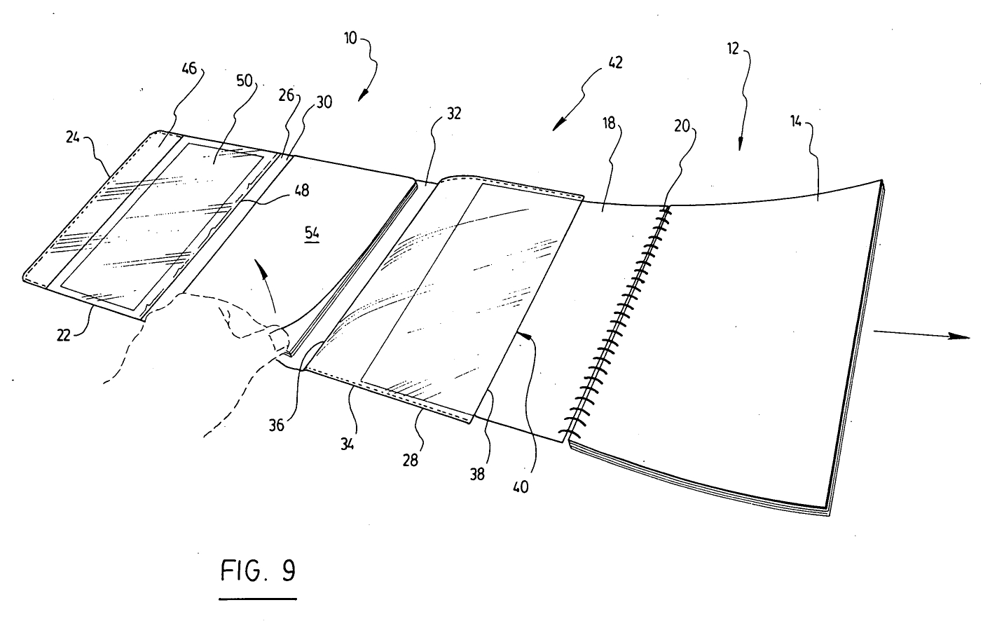

According to one aspect of the present invention, the planner booklet 10 has a set of pages 12 including a plurality of note pages 14 bearing date indicia 16 and a solid page 18. The planner booklet 10 has a binding device, such as annular rings 20, for binding together the set of pages 12. The planner booklet 10 has a front cover 22 having a first side 24 and a second side 26. The planner booklet 10 has a back cover 28 having a first side 30 and a second side 32. The first side 30 of the back cover 28 is flexibly connected to the second side 26 of the front cover 22. As best shown in FIG. 9, the planner booklet 10 has an extension flap 34 having a first side 36 and a second side 38. The first side 36 of the flap 34 is flexibly connected to the second side 32 of the back cover 28. The second side 38 of the flap 34 has a receiving pocket 40 for receiving the solid page 18 of the set of pages 12. The flap 34 is movable between an extended position 42, which is best shown in FIGS. 7 and 9, where the flap 34 is positioned away from the back cover 28 and a retracted position 44, which is best shown in FIG. 8, where the flap 34 is positioned against the back cover 28. Thereby, when the solid page 18 is inserted in the receiving pocket 40 of the flap 34, a user is able to flip the note pages 14 underneath the solid page 18 by moving the flap 34 between the extended and retracted positions 42, 44.

The above-described planner booklet 10 configuration is advantageous because a user may close the planner booklet 10 on a particular date of the week or month of the year, without having to flip the pages to go to the current date or month as is needed in known planners with tear out portions.

The above-described planner booklet 10 configuration is also advantageous because it may be assembled as two main separate parts, as best shown in FIG. 9. The first part includes the front cover 22, the back cover 28 and the flap 34. The second part includes the set of pages 12 with the note pages 14 and solid page 18 bound together by the binding device 20. Thereby, the first and second parts may be manufactured separately and assembled together at a later stage, increasing its production efficiency.

Preferably, the front cover 22 includes a transparent strip 46 or clear window portion extending along the first side 24 of the front cover 22 for allowing a user to reference the note pages 14 when the front cover 22 is closed. This feature is particularly advantageous when the note pages 14 have the date indicia 16, such as an identification of the current date or month, being positioned in register with the transparent strip 46 when the front cover 22 is positioned against one of the note pages 14. In this way a user may view a week of a month as best shown in FIG. 3a or several months of a year as best shown in FIG. 3b. In use, a user may fold the pages underneath the other pages, and view the newly weekly or monthly reference through the transparent strip 46 or clear window portion when the front cover 22 is closed.

The solid page 18 may be made of cardboard material. Of course, any other suitable solid material such as plastic may be used as those skilled in the art will understand. The annular rings 20 used as the binding device may also be a continuous spiral ring or any other suitable binding device achieving the same function, as those persons skilled in the art will understand.

Preferably, the front cover 22 includes a pocket 48 for receiving an annual calendar page 50 that is insertable along the second side 26 of the front cover 22.

Preferably, the back cover 28 includes a pocket 52, which is best shown in FIG. 7, for receiving a telephone directory 54 that is insertable along the first side 30 of the back cover 28.

Preferably, the front cover 22, the back cover 28 and the flap 34 are made of a flexible plastic material.

According to an alternative embodiment of the present invention, the planner booklet 10 shown in FIGS. 1 to 9 is slightly modified from the version disclosed above by removing the solid page 18 and integrating the binding device 20 directly into the second side 38 of the flap 34. In this embodiment, the planner booklet 10 also has a set of pages 12 including a plurality of note pages 14 bearing date indicia 16. The planner booklet 10 also has a front cover 22 having a first side 24 and a second side 26. The planner booklet 10 also has a back cover 28 having a first side 30 and a second side 32. The first side 30 of the back cover 28 is flexibly connected to the second side 26 of the front cover 22. The planner booklet 10 also has an extension flap 34 having a first side 36 and a second side 38. The first side 36 of the flap 34 is flexibly connected to the second side 32 of the back cover 28. The second side 38 of the flap 34 has a binding device for binding together the set of pages 12. The flap 34 is movable between an extended position 42 where the flap 34 is positioned away from the back cover 28 and a retracted position 44 where the flap 34 is positioned against the back cover 28. Thereby, in use, a user is able to flip the note pages 12 underneath the flap 34 by moving the flap 34 between the extended and retracted positions 42, 44.

With the planner booklet of the present invention, it is much easier and faster for a user to search for the right page corresponding to the current date. In use, the left hand pages fold under the right hand pages and allow a view of the current week or of the current month.

Although preferred embodiments of the present invention has been described in detail herein and illustrated in the accompanying drawings, it is to be understood that the invention is not limited to these precise embodiments and that various changes and modifications may be effected therein without departing from the scope or spirit of the present invention.

1. A planner booklet, comprising:
a set of pages including a plurality of note pages bearing date indicia and a solid page;
a binding means for binding together the set of pages;
a front cover having a first side and a second side;
a back cover having a first side and a second side, the first side of the back cover being flexibly connected to the second side of the front cover; and
an extension flap having a first side and a second side, the first side of the flap being flexibly connected to the second side of the back cover, the second side of the flap having a receiving pocket for receiving the solid page of the set of pages, the flap being movable between an extended position where the flap is positioned away from the back cover and a retracted position where the flap is positioned against the back cover, whereby, when the solid page is inserted in the receiving pocket of the flap, a user is able to flip the note pages underneath the solid page by moving the flap between the extended and retracted positions.

2. The planner booklet according to claim 1, wherein the front cover includes a transparent strip extending along the first side of the front cover, and wherein the note pages have the date indicia positioned in register with the transparent strip when the front cover is positioned against one of the note pages.

3. The planner booklet according to claim 2, wherein the date indicia includes daily dates of a week.

4. The planner booklet according to claim 2, wherein the date indicia includes monthly dates of a year.

5. The planner booklet according to claim 1, wherein the solid page is made of cardboard material.

6. The planner booklet according to claim 1, wherein the binding means includes a set of annular rings.

7. The planner booklet according to claim 1, wherein the front cover includes a pocket for receiving an annual calendar page insertable along the second side of the front cover.

8. The planner booklet according to claim 1, wherein the back cover includes a pocket for receiving a telephone directory insertable along the first side of the back cover.

9. The planner booklet according to claim 1, wherein the front cover is made of a flexible plastic material.

10. The planner booklet according to claim 1, wherein the back cover and the flap are made of a flexible plastic material.

11. A planner booklet, comprising:
a set of pages including a plurality of note pages bearing date indicia;
a front cover having a first side and a second side;
a back cover having a first side and a second side, the first side of the back cover being flexibly connected to the second side of the front cover; and
an extension flap having a first side and a second side, the first side of the flap being flexibly connected to the second side of the back cover, the second side of the flap having a binding means for binding together the set of pages, the flap being movable between an extended position where the flap is positioned away from the back cover and a retracted position where the flap is positioned against the back cover, whereby, in use, a user is able to flip the note pages underneath the flap by moving the flap between the extended and retracted positions.

12. The planner booklet according to claim 11, wherein the front cover includes a transparent strip extending along the first side of the front cover, and wherein the note pages have the date indicia positioned in register with the transparent strip when the front cover is positioned against one of the note pages.

13. The planner booklet according to claim 12, wherein the date indicia includes daily dates of a week.

14. The planner booklet according to claim 12, wherein the date indicia includes monthly dates of a year.

15. The planner booklet according to claim 11, wherein the solid page is made of cardboard material.

16. The planner booklet according to claim 11, wherein the binding means includes a set of annular rings.

17. The planner booklet according to claim 11, wherein the front cover includes a pocket for receiving an annual calendar page insertable along the second side of the front cover.

18. The planner booklet according to claim 11, wherein the back cover includes a pocket for receiving a telephone directory insertable along the first side of the back cover.

19. The planner booklet according to claim 11, wherein the front cover is made of a flexible plastic material.

20. The planner booklet according to claim 11, wherein the back cover and the flap are made of a flexible plastic material.
